(19) United States
(12) Patent Application Publication
(10) Pub. No.: US 2011/0093309 A1
(43) Pub. Date: Apr. 21, 2011

(54) SYSTEM AND METHOD FOR PREDICTIVE CATEGORIZATION OF RISK

(75) Inventors: N. DAYASINDHU, Bangalore (IN); Marti SUBRAHMANYAM, New York, NY (US); Devendra AWASTHI, Bangalore (IN); Nabarun ROY, Bangalore (IN)

(73) Assignee: INFOSYS TECHNOLOGIES LIMITED, Bangalore (IN)

(21) Appl. No.: 12/859,420

(22) Filed: Aug. 19, 2010

(30) Foreign Application Priority Data
Aug. 24, 2009 (IN) 2003/CHE/2009

(51) Int. Cl. G06Q 10/00

(52) U.S. Cl. 705/7.28

(57) ABSTRACT

A system and method for predictive categorization of risk of at least one project related activity is provided. The system and method provide categorization of the project related activity into one of a plurality of predetermined risk categories. Further, the risk category of the project related activity is predicted in at least one stage of the project life cycle. The method comprises collecting inputs pertaining to the project related activity being categorized and a predetermined set of details for categorizing the project related activity. The method further comprises categorizing the project related activity by applying discriminant analysis. The application of discriminant analysis comprises constructing a set of functions based on the predetermined set of details. Thereafter, the constructed set of functions are applied on the details collected pertaining to the project related activity, wherein the functions are applied for predicting the risk category of the project related activity.

### FIELD OF INVENTION

The present invention relates generally to risk management. More specifically, the present invention relates to predictive categorization of risk for various projects.

### BACKGROUND OF THE INVENTION

Risk management forms an integral part of project management and refers to the process of identifying and measuring risks associated with projects and subsequently developing strategies to mitigate the identified risks. Projects may involve various risks related to costs, resources, quality etc., which if not mitigated might lead to undesired consequences such as cost overruns, resource deficits, quality issues etc., during different stages of the project life cycle. Various risk management models are employed after initiation of projects, when detailed project execution plans have been developed or when projects are in execution stage, to effectively manage risks during the execution stage of the projects and to determine the consequences of such risks.

There are however, no specific models for determining risks during the initial stages of the project life cycle, especially while making project proposals and contracts. The risk determination in the initial stages is typically performed by authorized users such as project managers, risk managers etc., based on past experience or analysis of historical data. Generally, the authorized users determine and categorize the risks associated with projects by defining threshold levels based on past experience and historical data. Alternately, risks are identified based on analysis of various independent variables such as resource requirements, project related assumptions etc., which are identified from a ‘root cause analysis’ of the historical data of various projects. Thereafter, the identified variables are provided to typical proposal management systems, which use these variables to devise questionnaires for determining the risks associated with projects. These questionnaires are devised from heuristics and are based on various factors such as prior experience, geographical location of the customer firm, estimated revenues and so on. In addition, the questionnaires comprise questions with different weights, wherein the weights are also assigned based on heuristics and past experience. The response to these questionnaires is used for determining the risks associated with the projects in the initial stages.

The abovementioned models have one or more of the following limitations. The risk mitigation approach devised based on the traditional risk management models might not be effective, as the assessment of risk is performed during post-initiation stages. Further, a delayed determination may lead to an escalation in costs. The accuracy in determining risks during the initiation stage is subject to the perception and experiences of the authorized users determining project risks. Further, since the questionnaires used for categorizing risks are devised based on inputs provided by the authorized users, they might also lead to incomplete and inaccurate determination of risks. Results from research conducted on risk determination using traditional models indicate that there is a high degree of inaccuracy in determining and categorizing risks at various stages of the project life cycle, which eventually leads to undesired consequences such as cost escalations and deadline extensions.

Consequently, there is a need for a system and method for effective risk management. Further, the system and method should enable accurate determination and categorization of risk in various stages of the project life cycle and more specifically the initial stages.

### SUMMARY OF THE INVENTION

A system, method and computer program product for predictive categorization of risk of at least one project related activity is provided. The system and method provide categorization of the project related activity into one of a plurality of predetermined risk categories. In an exemplary embodiment of the present invention, the predetermined risk categories comprise the categories high risk and non-high risk. Further, the risk category of the project related activity is predicted in at least one stage of the project life cycle.

In various embodiments of the present invention, the system comprises an input module configured to collect inputs comprising details pertaining to the project related activity being categorized and a predetermined set of details for categorizing the project related activity.

In various embodiments of the present invention, the predetermined set of details comprises at least one of user-defined variables for categorizing the project related activity; the predetermined risk categories based on which the project related activity needs to be categorized; and historical data of one or more projects. In an embodiment of the present invention, the user-defined variables comprise at least one of independent variables and dummy variables for constructing the set of functions. In addition, the historical data of the projects comprises independent variables used for categorizing project related activities of the one or more projects and the risk categorization of the project related activities.

In various embodiments of the present invention, the input module is further configured to collect the inputs via one or more user interfaces. Further, the user interfaces are at least one of, but not limited to user interfaces for creating at least one of a business opportunity, a project proposal and a project contract; and user interfaces for capturing risk information associated with the project related activity from at least one authorized user.

In an embodiment of the present invention, the input module is configured to collect the predetermined set of details from one or more project management systems.

The system further comprises a risk categorization module configured to categorize the project related activity into one of a plurality of predetermined risk categories. The risk categorization module predicts the risk category by applying a predetermined statistical technique on the collected inputs. In an exemplary embodiment of the present invention, the predetermined statistical technique is discriminant analysis.

In various embodiments of the present invention, the system comprises a repository configured to store and retrieve information related to one or more projects. In an embodiment of the present invention, the repository is configured to store inputs collected via the input module.

In various embodiments of the present invention, the risk categorization module is configured to collect the inputs stored in the repository for predicting the risk category of the project related activity. In addition, the risk categorization module is configured to forward the details of the categorization for storage to the repository.

In an embodiment of the present invention, the risk categorization module is configured to generate a predictive risk model for categorizing the project related activity. The predictive risk model is generated based on at least one of the collected inputs; user-defined variables collected from at least one authorized user via the input module; and a set of functions constructed based on the collected inputs and the user-defined variables, wherein the set of functions are applied for categorizing the project related activity. In addition, the system is configured to enable modification in the predictive risk model based on modification inputs provided by the authorized user.

In various embodiments of the present invention, the system comprises an output module configured to generate an output comprising the categorization of the project related activity. In various embodiments of the present invention, the output module is further configured to provide the generated outputs to at least one project management system.

In various embodiments of the present invention, the method for predictive categorization of risk comprises collecting details pertaining to the project related activity being categorized and a predetermined set of details for categorizing the project related activity.

The method further comprises categorizing the project related activity by applying discriminant analysis. In an embodiment of the present invention, the application of discriminant analysis comprises constructing a set of functions based on the predetermined set of details.

In an embodiment of the present invention, the set of functions are constructed based on the independent variables of the historical data; and one or more assumptions related to the independent variables.

In an embodiment of the present invention, the set of functions are reconstructed. The reconstruction comprises categorizing the project related activities of the historical data based on the constructed set of functions; and reconstructing the set of functions based on the categorization of the project related activities. In an exemplary embodiment of the present invention, the categorization and reconstruction is performed till at least one of a predetermined number of iterations; and the reconstructed set of functions provides results with a predetermined level of accuracy.

Thereafter, the application of discriminant analysis comprises applying the constructed set of functions on the details collected pertaining to the project related activity for predicting the risk category of the project related activity. In an exemplary embodiment of the present invention, the application of discriminant analysis comprises constructing a final set of functions based on the reconstructed set of functions, wherein the final set of functions are used for predicting the risk category of the project related activity.

In various embodiments of the present invention, the method further comprises generating an output comprising the predicted risk category of the project related activity.

In various embodiments of the present invention, the computer program product for predictive categorization of risk comprises program instruction means for collecting details pertaining to the project related activity being categorized and a predetermined set of details for categorizing the project related activity.

The computer program product further comprises program instruction means for categorizing the project related activity by applying discriminant analysis. The application of discriminant analysis comprises constructing a set of functions based on the predetermined set of details. Thereafter, the application of discriminant analysis comprises applying the constructed set of functions on the details collected pertaining to the project related activity for predicting the risk category of the project related activity.

In various embodiments of the present invention, the computer program product further comprises program instruction means for generating an output comprising the predicted risk category of the project related activity.

### BRIEF DESCRIPTION OF THE ACCOMPANYING DRAWINGS

The present invention is described by way of embodiments illustrated in the accompanying drawings wherein:

FIG. 1A illustrates a block diagram of a system for predictive categorization of risks, in accordance with an embodiment of the present invention;

FIGS. 1B to 1E illustrate exemplary user interfaces rendered via the system for predictive categorization of risks; and

FIG. 2 is a flowchart illustrating a method for predictive categorization of risks, in accordance with an embodiment of the present invention.

### DETAILED DESCRIPTION OF THE INVENTION

The present invention provides a system and method for risk management. More specifically, the present invention provides a system and method for predictive categorization of risks for various projects. In various embodiments of the present invention, the categorization of risks is performed for identifying risk categories of various project related activities at one or more stages of the project life cycle. The categorization is performed by collecting inputs pertaining to the project related activities which need to be categorized and data based on which the project related activities can be categorized. Thereafter, predetermined categorization techniques are applied on the collected inputs for predictive categorization of risks. Subsequently, outputs are generated based on the categorization and presented to authorized users such as project managers, risk managers etc. for determining strategies for mitigating the identified risks.

The disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

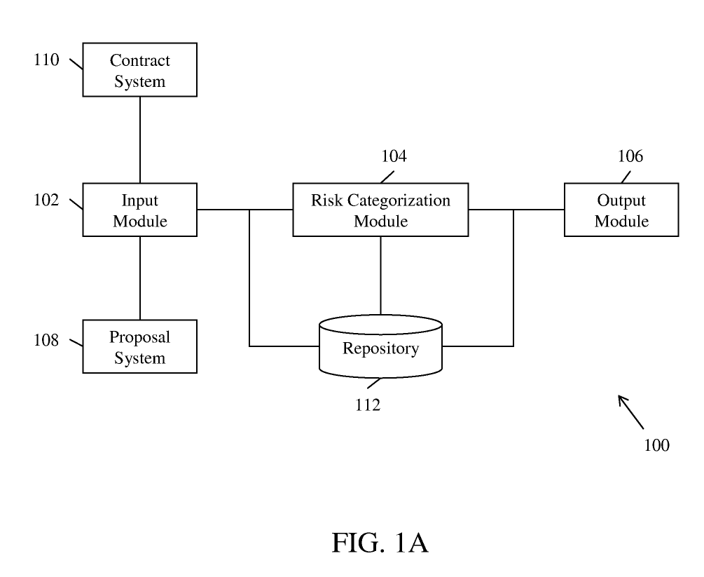

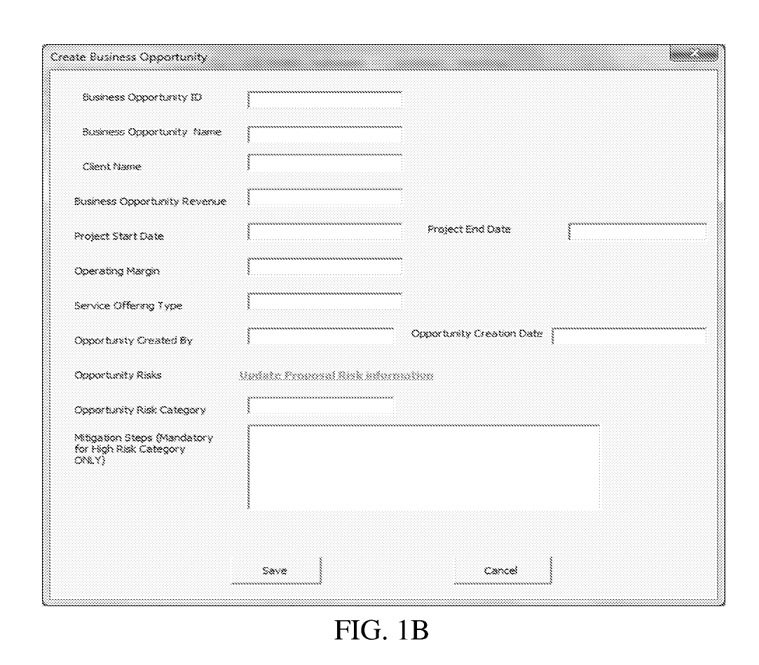

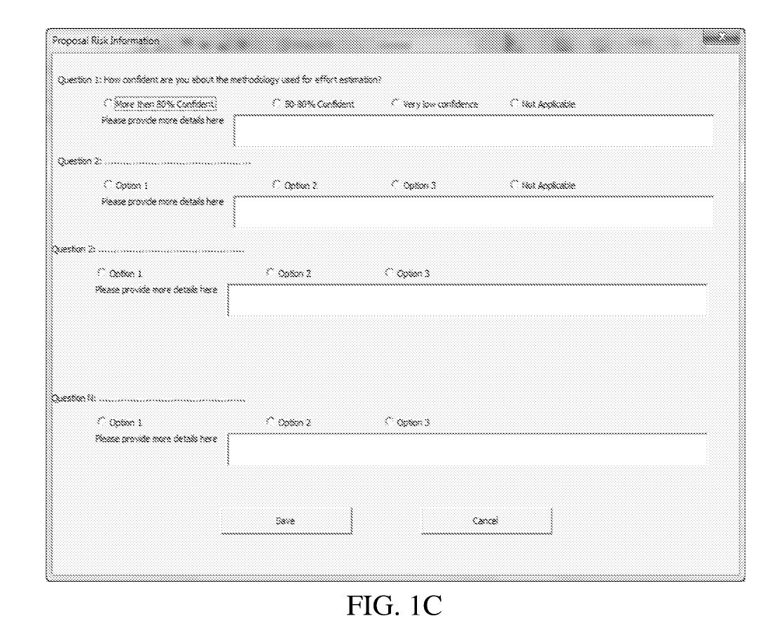

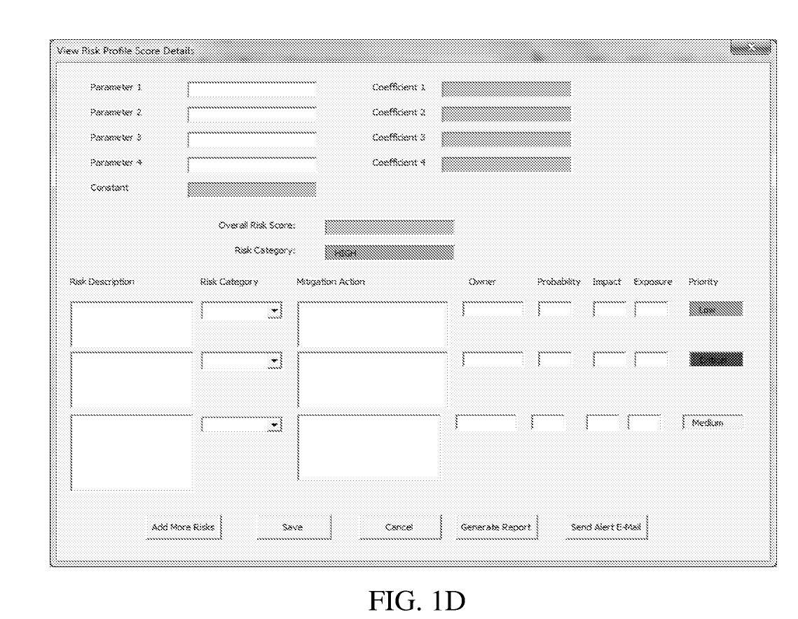

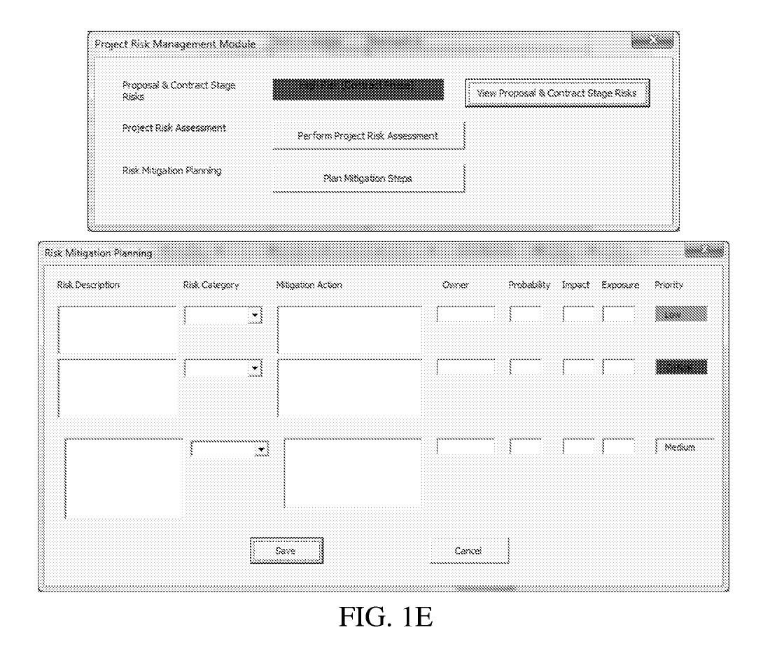

FIG. 1A illustrates a block diagram of a system for predictive categorization of risks, in accordance with an embodiment of the present invention. As illustrated, system 100 comprises an input module 102, a risk categorization module 104 and an output module 106.

Input module 102 is configured to collect inputs pertaining to one or more projects at various stages of the project life cycle. In various embodiments of the present invention, the inputs comprise a predetermined set of details such as business opportunity details, project proposal details, project contract details, service level agreement details, customer requirements, operating margins, estimated timelines, projected revenues, historical data related to various projects and so forth.

The inputs also comprise risk information such as proposal risk information, contract risk information, project risk information and so forth. Further, the inputs comprise independent variables, also referred to as predictor variables, for predictive categorization of risks of various project related activities such as business opportunities, project proposals, project activities including software development, testing etc. Independent variables can be one of user-defined variables and independent variables defined for risk categorization of previous projects. In an exemplary embodiment of the present invention, independent variables are one of, but not limited to, projected revenues, effort estimates, operating margins and project maturity details. The collected inputs further comprise the risk categorization of various project related activities of previous projects.

Input module 102 is also configured to collect inputs from authorized users such as project managers, proposal team members, risk management team members etc. In various embodiments of the present invention, input module 102 is configured to enable collection of inputs from authorized users via a user interface such as a Graphical User Interface (GUI), a Web-based User Interface (WUI), a command line interface, a tactile interface, a touch user interface and so forth.

In an embodiment of the present invention, input module 102 is configured to collect inputs pertaining to creation of various project related activities such as for creation of business opportunities, project proposals, contracts and so forth. An exemplary user interface rendered by input module 102 for creating business opportunities is illustrated in FIG. 1B. In addition, input module 102 enables gathering of risk information via the user interface, such as proposal risk information can be gathered via the exemplary user interface illustrated in FIG. 1C.

Input module 102 is also configured to collect inputs from various project management systems such as a proposal system 108, a contract system 110 and other systems (not shown) such as project planning systems, project revenue estimation systems and so forth.

In an embodiment of the present invention, input module 102 collects inputs pertaining to historical data from a repository 112. Input module 102 also transmits the collected inputs to repository 112 for storage.

In various embodiments of the present invention, repository 112 enables storage and retrieval of information related to various projects. For example, repository 112 enables storage and subsequent retrieval of information related to business opportunities. In an exemplary embodiment, repository 112 is a database including a set of tables. Further, repository 112 enables digital storage of data. For example, repository 112 includes a database with tables for storing business opportunity ID, business opportunity name, client, project details etc. Further, the database is one of, but not limited to, a relational database, operational database, analytical database, external database, navigational database and document oriented database.

Risk categorization module 104 is configured to receive the collected inputs from input module 102 and predict risk categories of various project related activities based on the received inputs. In an embodiment of the present invention, risk categorization module 104 gathers the collected inputs from repository 112.

In various embodiments of the present invention, risk categorization module 104 is configured to apply predetermined categorization techniques on the collected inputs for predicting the categories of risks of various project related activities. In various embodiments of the present invention, the project related activities are one of business opportunities, project proposals, projects, project initiation and execution activities such as software planning, design, development, testing and so forth. Examples of predetermined categorization techniques comprise Discriminant Analysis (DA), Principal Component Analysis (PCA), Multiple Linear Regression (MLR) and so forth.

In an embodiment of the present invention, risk categorization module 104 applies DA on the collected inputs for predictive categorization of risk. DA is a technique used to classify cases, also referred to as objects or activities, into one of a plurality of categories based on features associated with the activities. For example, DA can be used to classify projects into the categories high risk and low risk, based on various factors such as estimated revenues, operating margins, resource requirements etc. In the abovementioned example, the projects are the activities and the factors are the features associated with the activities. In various embodiments of the present invention, the activities are the project related activities and the features are the independent variables.

In an exemplary embodiment of the present invention, risk categorization module 104 utilizes predefined functions of one or more statistical tools for applying DA on the collected inputs. For example, risk categorization module utilizes a Statistical Package for Social Sciences (SPSS) for applying DA on the collected inputs. Further, risk categorization module 104 is configured to define functions to be applied for predictive categorization of risk using the statistical tools. In addition, risk categorization module 104 is configured to incorporate plugins/software codes in the software tools to enhance their functionality. Various other statistical packages such as Statistical Analysis System (SAS), or combination of such packages may also be used to apply DA for predictive risk categorization.

In an exemplary embodiment of the present invention, risk categorization module 104 generates a predictive risk model based on the collected inputs. The predictive risk model comprises a set of functions for predictive risk categorization. Further, the predictive risk model is rendered to authorized users via the user interface, which enables users to validate and modify the predictive risk model. It will be apparent that the rendering of the models via the user interface enables developing, modifying, updating and copying predictive risk models, wherein corresponding actions can be performed for the entire risk models or parts of the risk models. An exemplary user interface rendering a predictive risk model is illustrated in FIG. 1D. As illustrated, the user interface may be used to develop the model for predictive categorization of risk. In addition, the user interface may be used to update the model at a later stage, based on the updates in the collected inputs.

In various embodiments of the present invention, risk categorization module 104 transmits the predicted risk categories of various project related activities to repository 112 for storage.

Output module 106 is configured to generate outputs based on the risk categories predicted by risk categorization module 104. In an embodiment of the present invention, output module 106 is configured to generate the outputs based on data stored in repository 112.

In various embodiments of the present invention, output module 106 generates the output in predetermined formats such as text formats, graphical formats, web-based formats etc. Further, the outputs include a predetermined set of details such as the risk category, proposed risk mitigation measures etc. In an exemplary embodiment of the present invention, the outputs are used for determining strategies for mitigating the identified risks.

In various embodiments of the present invention, the generated outputs are rendered via the user interface of input module 102, wherein the outputs are one of Hyper Text Markup Language (HTML) documents, Extensible Markup Language (XML) representations and so forth. An exemplary user interface comprising outputs, that is rendered to users is illustrated in FIG. 1E. As illustrated, users can view details pertaining to risk categorization of project related activities in various stages such as the proposal and the contract stage. Further, the user interface may be used to plan risk mitigation actions. In addition, the user interface assists in assessing risks in various stages of the project life cycle.

In addition, the outputs rendered via the user interface can be stored digitally in a repository such as repository 112. Subsequently, the outputs can be modified and/or used for predictive risk categorization of other project related activities.

In an exemplary embodiment of the present invention, the outputs are provided to various project management systems, which are configured to enable tracking of the identified risks over the project life cycle. It will be apparent that such tracking enables effective risk management.

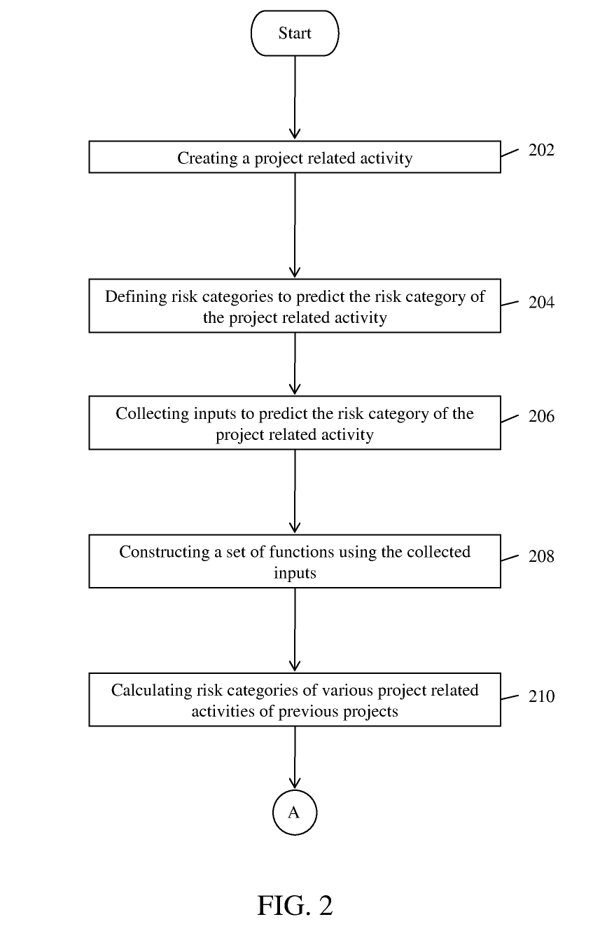

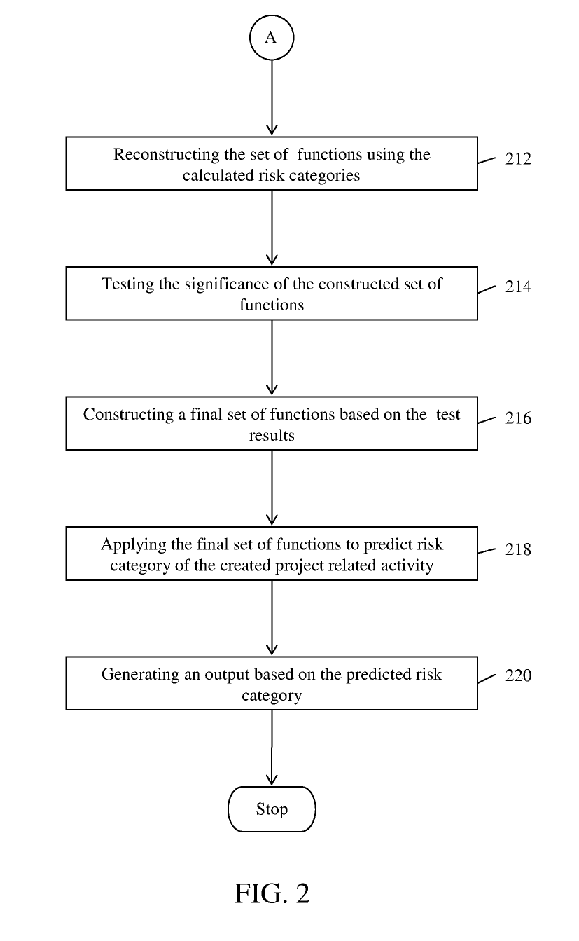

FIG. 2 is a flowchart illustrating a method for predictive categorization of risks, in accordance with an embodiment of the present invention.

At step 202, a business opportunity is created. In various embodiments of the present invention, business opportunities are created from details collected from authorized users such as project managers, proposal team members etc., via a user interface. For creating business opportunities, authorized users provide predetermined set of details such as business opportunity name, business opportunity identifiers, client name, projected revenue, timelines, operating margin, service offering type and business opportunity risk details. In various embodiments of the present invention, business opportunity risk details comprise responses to questions provided by the authorized users, wherein the responses are collected via the user interface, such as the exemplary user interface illustrated in FIG. 1C.

At step 204, risk categories are defined. In various embodiments of the present invention, prior to categorizing a project related activity risk categories are defined. Examples of project related activities that can be categorized comprise business opportunities, projects, project proposals, project contracts, various software development and testing activities etc. Further, the project related activities can be categorized into various risk categories such as “high risk, non-high risk”; “high risk, moderate/medium risk, low risk”; “very high risk, high risk, high-medium risk, medium risk, medium-low risk, low risk” etc. based on the service/customer requirements.

In an exemplary embodiment of the present invention, the risk categories are high risk and non-high risk, wherein the category non-high risk is used to represent project related activities of moderate or low risk. Further, higher probability values are assigned for categorizing high risk projects and moderate probability values are assigned for categorizing non-high risk projects. It will be apparent that the abovementioned logic aids in reducing costs and minimizing efforts, as it minimizes the risk of incorrectly categorizing high risk projects as non-high risk. This in turn minimizes costs resulting from extra effort, missing service level agreements, penalties etc., which might be incurred upon miscategorization of high risk projects as non-high risk, while creating business opportunities or making proposals.

At step 206, inputs are collected for categorizing project related activities into one or more risk categories. In various embodiments of the present invention, inputs are collected from at least one of authorized users and various project management systems such as proposal systems, contract systems, project planning systems, project revenue estimation systems and so forth.

The collected inputs comprise historical data of various projects. The historical data collected is typically referred to as training set or training data, which varies based on the type of project related activities being categorized. The collected inputs also comprise the independent variables of those projects and the risk categorization of various project related activities of the corresponding projects. For example, the collected inputs comprise independent variables, as illustrated in Table 1, for various maintenance and development projects at project initiation stage. It will be apparent that the number of variables need not be limited to those illustrated below, and may vary, depending on the type of projects or the model being used. Independent variables can also be user-defined variables collected from authorized users.

In various embodiments of the present invention, the collected inputs also comprise dummy variables, such as those illustrated in Table 1, for efficiently categorizing project related activities. Dummy variables take values to indicate the presence or absence of variables in the collected inputs, in order to prevent undesired predictions due to lack/misinterpretation of variables.

TABLE 1
Independent variables collected for a project XYZ categorized as high
risk

| | | Instance value of | |
|---|---|---|---|
| Independent | Description of the | the Independent | Dummy/Real |
| Variable | Independent Variable | Variable | Variable |
| Organization | Type of business unit | Software | Dummy |
| Unit | | Development | |
| Project | Duration of the Project in | 12 (from Jan. 1- | Real |
| Duration | Months | Dec. 31, 2008) | |
| (Months) | | | |
| Technology | Technology used in the | Cloud computing | Dummy |
| | project | | |
| Revenue/ | Total Revenue/Duration | USD 40,000/- per | — |
| Month | of project in months | month | |
| (USD/ | | | |
| month) | | | |
| Domain | Business domain the | Banking | Dummy |
| | project belongs to, like | | |
| | Retail, Banking, | | |
| | insurance etc. | | |
| Contract | FP (Fixed Price) or T&M | FP | Dummy |
| Type | (Time and Material) or | | |
| | CTM (Capped Time and | | |
| | Material) | | |

At step 208, the collected inputs are used to construct a set of functions. In an embodiment of the present invention, the collected inputs are used to construct a set of linear discriminant functions. Further, the linear discriminant functions are constructed based on various assumptions such as the independent variables being multivariate normally distributed, the independent variables being independent and non-collinear, the variance-covariance matrices of the independent variables of various categories being homogenous, the relationship between the independent variables being linear, the absence of outliers in the collected data and so forth.

In an exemplary embodiment of the present invention, the set of linear discriminant functions comprises functions such as:

L=B₁X₁+B₂X₂+ . . . +BₙXₙ+c;

wherein, L is a dependent variable, Bᵢ's (for all i=1, 2, . . . , n) are discriminant coefficient's, Xᵢ's (for all i=1, 2, . . . , n) are the independent variables and c is a constant. In an exemplary embodiment of the present invention, the discriminant coefficients and the constant are based on the process type of business opportunity and the stage in the project life cycle for which the project related activities are being categorized. The process types of business opportunities are one of software development, maintenance, package implementation, re-engineering etc. and the risk category determination is performed for one of, but not limited to, the proposal stage and the contract stage.

In various embodiments of the present invention, the cardinality of the set of functions is equal to the number of risk categories. For example, the cardinality of the set of functions is two, when project related activities need to be categorized into high risk and non-high risk. Similarly, the cardinality of the set of functions is ‘k’, when project related activities need to be categorized into ‘k’ categories. Further, each function corresponds to a defined category. The risk category of project related activities is typically estimated based on the outputs of the set of functions, wherein the estimation is performed by comparing the values of the outputs. Generally, the risk category is the category corresponding to the function which returns the maximum value. In an exemplary embodiment of the present invention, the value returned by a function is referred to as a risk score.

At step 210, the risk category for each project related activity of the previous projects is calculated based on the constructed set of functions. For example, the project XYZ is categorized as high risk based on two discriminant functions created based on the collected inputs. Thereafter, based on the output, the data pertaining to the independent variables and risk categorization of project related activities of previous projects is updated.

At step 212, the set of functions are re-constructed using the updated categorization of project related activities of previous projects.

In an exemplary embodiment of the present invention, steps 210 and 212 are performed iteratively till a predetermined number of iterations. Alternately, steps 210 and 212 are performed iteratively till the results obtained from the set of functions constructed prior to an iteration are identical to the results obtained from the set of functions constructed after the iteration.

In various exemplary embodiments of the present invention, dummy variables are eliminated based on predetermined criteria. For example, dummy variables are eliminated after a predetermined number of iterations. In another example, one or more dummy variables are eliminated after each iteration. Table 2 illustrates an example of the reduction in the dummy variables, based on a higher level of abstraction, after the first iteration.

TABLE 2
List illustrating reduction of dummy variables between Iteration 1 and
2 based on higher level of abstraction. (Only variables that were
modified are shown)

| | Independent | |
|---|---|---|
| Independent variables | variables in | |
| in Iteration 2. Number | Iteration 1. Number of | |
| of variables shown in ( ) | variables shown in ( ) | Comments |
| Country variables (8) | Country variables (11) | Dummy. |
| | | Used a higher level of |
| | | abstraction. |
| Technology | Technology | Dummy. |
| Variables (15) | Variables (33) | Used a higher level of |
| | | abstraction. |

In an exemplary embodiment of the present invention, the DA is applied again to the reduced set of variables to generate a new set of discriminant functions, as described in steps ‘210’ and ‘212’. Thereafter, the accuracy in the categorization of variables is determined. Subsequently, based on the determination, the variables with higher levels of accuracy are selected for further application/construction of functions. An example of increase in accuracy is illustrated in Table 3.

TABLE 3
The improvement in correct categorization of high risk projects in
Iteration 2

| | Correct categorization | |
|---|---|---|
| Study Group - | of high risk as high risk | Correct categorization of high |
| Type of | in the not selected | risk as high risk in the not |
| project | case - Iteration 2 (%) | selected case - Iteration 1 (%) |
| Maintenance | 50.0 | 42.9 |
| Development | 88.2 | 68.0 |

Each iteration typically leads to an increase in accuracy of categorizing project related activities and hence iterations are performed till a desired level of accuracy is achieved. Examples of increase in accuracy in iterations are illustrated in tables 4 and 5.

TABLE 4
List illustrating reduction of dummy variables between Iteration 2 and
3 based on higher level of abstraction. (Only variables that were
modified are shown)

| | Independent | |
|---|---|---|
| | variables | |
| Independent variables | in Iteration 2. | |
| in Iteration 3. Number | Number | |
| of variables shown in | of variables | |
| ( ) | shown in ( ) | Comments |
| Geographic variables (7 | Geographic | Dummy. |
| for Maintenance and 5 | variables (8) | Used a higher level of |
| for Development) | | abstraction. |
| No technology | Technology | Quality of data for technology |
| variables used (0) | Variables (15) | variables at proposal stage of |
| | | project is unreliable since the |
| | | choice of technology is |
| | | typically not finalized |

TABLE 5
The improvement in correct categorization of high risk projects in
Iteration 3 for maintenance projects

| | Correct categorization | |
|---|---|---|
| Study Group - | of high risk as high risk | Correct categorization of high |
| Type of | in the not selected | risk as high risk in the not |
| project | case - Iteration 3 (%) | selected case - Iteration 2 (%) |
| Maintenance | 71.4 | 50.0 |
| Development | 82.4 | 88.2 |

As illustrated, there is a significant change in the level of accuracy in categorizing project related activities after Iteration 3.

In various exemplary embodiments of the present invention, independent variables used for constructing the set of functions are changed to change the level of accuracy in categorizing project related activities. For example, four independent variables are used for constructing the set of functions in Iteration 4, while eight independent variables were used for constructing the set of functions in Iteration 3. Table 6 illustrates the change in level of accuracy in categorizing project related activities after Iteration 4. It will be apparent that the choice of independent variables depends on the type of project related activities being categorized.

TABLE 6
The improvement in correct categorization of high risk projects in
Iteration 4 for maintenance projects

| | Correct categorization | |
|---|---|---|
| Study Group - | of high risk as high risk | Correct categorization of high |
| Type of | in the not selected | risk as high risk in the not |
| project | case - Iteration 4 (%) | selected case - Iteration 3 (%) |
| Maintenance | 80.0 | 71.4 |
| Development | 78.9 | 82.4 |

An analysis of the changes in various iterations, as illustrated in tables 2-6, indicates that the accuracy in categorization of high risk maintenance projects improved from 42.9 percent in Iteration 1 to 80.0 percent in Iteration 4, while the accuracy in categorization of high risk development projects improved from 68.0 percent in Iteration 1 to 78.9 percent in Iteration 4.

Table 7 illustrates an exemplary summary of categorization of project related activities for maintenance projects obtained using risk categorization module 104. Further, the categorization illustrated in Table 7 depicts results obtained using one or more predefined functions of statistical tools. It will be apparent that results may be obtained in various other formats than that illustrated in Table 7. The categorization summary indicates that the model provides a predictive capability of more than 78.8% of the cross validated cases.

TABLE 7
Categorization Summary for Maintenance Projects
Categorization Results^{b,c,d}

| | | | | Predicted Group | | |
|---|---|---|---|---|---|---|
| | | | High | Membership | | |
| | | | Risk | 0 | 1 | Total |
| Cases | Original | Count | 0 | 2579 | 690 | 3269 |
| Selected | | | 1 | 8 | 27 | 35 |
| | | % | 0 | 78.9 | 21.1 | 100.0 |
| | | | 1 | 22.9 | 77.1 | 100.0 |
| | Cross-validated^{a} | Count | 0 | 2578 | 691 | 3269 |
| | | | 1 | 8 | 27 | 35 |
| | | % | 0 | 78.9 | 21.1 | 100.0 |
| | | | 1 | 22.9 | 77.1 | 100.0 |
| Cases | Original | Count | 0 | 1072 | 315 | 1387 |
| Not | | | 1 | 3 | 12 | 15 |
| Selected | | % | 0 | 77.3 | 22.7 | 100.0 |
| | | | 1 | 20.0 | 80.0 | 100.0 |

Note:
0 stands for non-high risk projects category and 1 stands for the high risk projects group
^{a}Cross validation is performed only for those cases, which were part of the analysis. In cross validation, each case was classified by the functions derived from all cases other than that case.
^{b}78.9% of selected original grouped cases were correctly classified.
^{c}77.3% of unselected original grouped cases were correctly classified.
^{d}78.8% of selected cross-validated grouped cases were correctly classified.

At step 214, one or more tests are conducted to test the significance of the results obtained after performing the iterations described in steps 210 and 212.

In an exemplary embodiment of the present invention, the test of equality of group means is performed to test the assumption of homogeneity of the variance-covariance matrices of the independent variables. The determination is made by analyzing the log determinant values of the covariance matrices, wherein a relatively equal log determinant value represents homogeneity in covariance matrices. Exemplary results of the test of equality are illustrated in tables 8 and 9.

TABLE 8
Tests of Equality of Group Means for Maintenance Projects
Tests of Equality of Group Means

| | Wilks' | | | | |
|---|---|---|---|---|---|
| | Lambda | F | df1 | df2 | Sig. |
| Variable 1 | 0.978 | 73.809 | 1 | 3302 | 0.000 |
| Variable 2 | 0.981 | 65.612 | 1 | 3302 | 0.000 |
| Variable 3 | 0.997 | 8.700 | 1 | 3302 | 0.003 |
| Variable 4) | 0.997 | 9.729 | 1 | 3302 | 0.002 |

TABLE 9
Log Determinants for Maintenance Projects
Log Determinants

| HR - CR | Rank | Log Determinant |
|---|---|---|
| 0 | 4 | 7.883 |
| 1 | 4 | 4.421 |
| Pooled within-groups | 4 | 7.875 |

Note:
0 stands for non high risk projects group and 1 stands for the high risk projects group
The ranks and natural logarithms of determinants printed are those of the group covariance matrices.

In another embodiment of the present invention, the Box's M test is performed on the results to test the assumption of multivariate normality distribution of the independent variables. The results of the test are indicative of the difference in the covariance matrices of the categories. An exemplary set of results of the Box's M test is provided in table 10.

TABLE 10
Box's M Test for Maintenance Projects
Test Results

| Box's M | | 91.500 |
|---|---|---|
| F | Approximately | 8.758 |
| | df1 | 10.000 |
| | df2 | 14677.470 |
| | Sig. | .000 |

Tests null hypothesis of equal population covariance matrices.

The constructed set of functions provides accurate results, when the covariance matrices are homogenous. When the covariance matrices are non-homogenous, the constructed set of functions provides accurate results, if there are no outliers in the data used for constructing the set of functions. Further, when the sample size of the data being used for constructing the functions is large, small deviations in homogeneity are typically found to be significant. In order to determine the accuracy of the functions constructed from large samples, the results of the Box's M test need to be interpreted in conjunction with the results of the test of equality.

Various other tests such as the Press's Q test, the t test and so forth, can also be performed to validate the assumptions made prior to constructing the set of functions. For example, the Press's Q test is used when for categorization when samples of unequal sizes are used and the t test is used when the samples are of equal size.

At step 216, a final set of functions is constructed. In various embodiments of the present invention, the final set of functions is constructed using the coefficients of the set of functions obtained after step 212 and the construction is based on the results of the tests performed at step 214. It will be apparent that the coefficients vary depending on the type of project related activities for which risk categorization is being performed.

At step 218, the final set of functions is used for categorizing project related activities. In an embodiment of the present invention, the final set of functions is used for categorizing the business opportunity created at step 202. In various embodiments of the present invention, the risk categorization is performed for various stages of the project life cycle. In an exemplary embodiment of the present invention, the predictive risk categorization is performed for the proposal stage. In another exemplary embodiment of the present invention, the predictive categorization of risks is performed for the contract stage. The predictive categorization of risks is performed based on a set of parameters identified based on analysis of collected inputs. These parameters are subject to change based on changes in the inputs at various stages of the project life cycle. Therefore, the final set of functions needs to be modified based on such changes for obtaining up-to-date predictive risk categorization.

In an exemplary embodiment of the present invention, the final set of functions is used to develop a predictive risk model. Further, the predictive risk model is rendered to authorized users via the user interface, which enables them to validate and modify the predictive risk model. In addition, users can modify the predictive risk model at various stages of the project life cycle based on changes which may occur in those stages. It will be apparent that the predictive risk model can be developed based on a combination of user-defined variables and variables identified by analysis of historical data.

At step 220, outputs are generated based on the predicted risk categorization of the project related activities. The outputs comprise the results obtained at step 218 and analysis of those results. In an exemplary embodiment of the present invention, the outputs comprise risk mitigation actions generated based on analysis of past data. In various embodiments of the present invention, the output are one of, but not limited to, customized reports, charts depicting risk categorization of a portfolio of projects, analogous projects and risk mitigation actions taken for those projects. Further, the outputs may be provided for tracking of risks.

In various exemplary embodiments of the present invention, the generated outputs are rendered via a user interface such as a web browser and are one of Hyper Text Markup Language (HTML) documents, Extensible Markup Language (XML) representations and so forth. Further, the outputs can be stored digitally in a repository. Subsequently, the outputs can be modified and used for predictive risk categorization of other project related activities.

In an exemplary embodiment of the present invention, the outputs are provided to various project management systems, which are configured to create early warning signals and communicate the created signals to authorized users.

In an exemplary embodiment of the present invention, early warning signals are generated after the determination of the risk category of the project related activity. If the project related activity is categorized as ‘high risk’, an early warning signal is sent in the form of an electronic mail (e-mail) notification to authorized users such as proposal approvers, high risk review committee members etc. It will be apparent that such communication assists the authorized users in determining the criticality of the project related activity and in performing appropriate due-diligence for mitigating/reducing the risk associated with the project related activity.

Alternately, the system displays the risk category to authorized users via user interfaces, which enables the users to validate the risks and plan risk mitigation actions. Various other forms of communication such as Short Message Service (SMS) etc. may also be used to communicate the risk category of project related activities.

In various exemplary embodiments of the present invention, the identified risks can be tracked via various project management systems. For example, the risks identified based on the predictive categorization are provided to project management systems such as the project proposal and contract systems. Various authorized users can view the details of such risks via one or more user interfaces rendered through the project management systems. In addition, the authorized users can assess the validity of the risk of the project related activity in various stages of the project life cycle.

Further, various project related activities may be tracked simultaneously via the user interfaces. The project management systems may also be configured to enable flagging of project related activities categorized as ‘high risk’. It will be apparent that this enables continuous and efficient tracking of the risks involved in various project related activities at various stages of the project life cycle.

The system and method for predictive risk categorization described above is applicable for categorizing project related activities of various projects and the application is not limited to the examples illustrated. Numerous alternative applications will be apparent to those skilled in the art.

While the exemplary embodiments of the present invention are described and illustrated herein, it will be appreciated that they are merely illustrative. It will be understood by those skilled in the art that various changes in form and detail may be made therein without departing from or offending the spirit and scope of the invention.

What is claimed is:

1. A system for predictive categorization of risk of at least one project related activity, the categorization being performed for the project related activity in at least one stage of the project life cycle, the system comprising:
an input module configured to collect inputs comprising:
details pertaining to the project related activity being categorized; and
a predetermined set of details for categorizing the project related activity;
a risk categorization module configured to categorize the project related activity into one of a plurality of predetermined risk categories, the risk category being predicted by applying a predetermined statistical technique on the collected inputs; and
an output module configured to generate an output comprising the categorization of the project related activity.

2. The system of claim 1, wherein the input module is further configured to collect the inputs via one or more user interfaces, the user interfaces being at least one of:
a user interface for creating at least one of a business opportunity, a project proposal and a project contract; and
a user interface for capturing risk information associated with the project related activity from at least one authorized user.

3. The system of claim 1, wherein the input module is further configured to collect the predetermined set of details from one or more project management systems.

4. The system of claim 1 further comprising a repository configured to store and retrieve information related to one or more projects.

5. The system of claim 4, wherein the repository is further configured to store inputs collected via the input module.

6. The system of claim 5, wherein the risk categorization module is further configured to:
collect the inputs stored in the repository for predicting the risk category of the project related activity; and
forward the details of the categorization for storage to the repository.

7. The system of claim 1, wherein the risk categorization module is further configured to generate a predictive risk model for categorizing the project related activity, the predictive risk model being generated based on at least one of:
the collected inputs;
user-defined variables collected from at least one authorized user via the input module; and
a set of functions constructed based on the collected inputs and the user-defined variables, the set of functions being applied on the details collected pertaining to the project related activity, wherein the set of functions being applied to categorize the project related activity.

8. The system of claim 7, wherein the risk categorization module is further configured to enable modifications in the predictive risk model via modification inputs provided by the authorized user.

9. The system of claim 1, wherein the output module is further configured to enable storage of the outputs rendered via a user interface.

10. The system of claim 1, wherein the output module is further configured to provide the generated outputs to at least one project management system.

11. The system of claim 1, wherein the project related activity is at least one of a business opportunity, a project proposal, a project contract, a project and one or more activities of a project.

12. The system of claim 1, wherein the stage of the project life cycle is at least one of a business opportunity creation stage, a project proposal stage, a project contract stage and at least one project execution stage.

13. The system of claim 1, wherein the predetermined statistical technique is discriminant analysis.

14. A system for predictive categorization of risk of at least one project related activity, the categorization being performed for the project related activity in at least one stage of the project life cycle, the system comprising:
an input module configured to collect inputs comprising:
details pertaining to the project related activity being categorized; and
a predetermined set of details for categorizing the project related activity; and
a risk categorization module configured to categorize the project related activity into one of a plurality of predetermined risk categories, the risk category being predicted by applying discriminant analysis on the collected inputs.

15. A method for predictive categorization of risk of at least one project related activity, the categorization being performed for the project related activity in at least one stage of the project life cycle, the project related activity being categorized into one of a plurality of predetermined risk categories, the method comprising:
collecting details pertaining to the project related activity being categorized and a predetermined set of details for categorizing the project related activity; and
categorizing the project related activity by applying discriminant analysis, the application of discriminant analysis comprising:
constructing a set of functions based on the predetermined set of details; and
applying the constructed set of functions on the details collected pertaining to the project related activity, the functions being applied for predicting the risk category of the project related activity.

16. The method of claim 15 further comprising generating an output comprising the predicted risk category of the project related activity.

17. The method of claim 15, wherein the predetermined set of details comprises at least one of:
user-defined variables for categorizing the project related activity;
the predetermined risk categories based on which the project related activity needs to be categorized; and
historical data of one or more projects, the historical data comprising:
independent variables used for categorizing project related activities of the one or more projects;
the risk categorization of the project related activities;

18. The method of claim 17, wherein the user-defined variables comprise at least one of independent variables and dummy variables for constructing the set of functions.

19. The method of claim 17, wherein the predetermined risk categories comprise the categories high risk and non-high risk.

20. The method of claim 17, wherein the set of functions are constructed based on:
the independent variables of the historical data; and
one or more assumptions related to the independent variables.

21. The method of claim 20 further comprising:
categorizing the project related activities of the historical data based on the constructed set of functions; and
reconstructing the set of functions based on the categorization of the project related activities;
wherein, the categorization and reconstruction being performed till at least one of:
a predetermined number of iterations; and
the reconstructed set of functions provides results with a predetermined level of accuracy.

22. The method of claim 21 further comprising testing the reconstructed set of functions to validate the assumptions related to the independent variables.

23. The method of claim 22 further comprising constructing a final set of functions based on the reconstructed set of functions, the final set of functions being used for predicting the risk category of the project related activity.

24. The method of claim 15, wherein the project related activity is at least one of a business opportunity, a project proposal, a project contract, a project and one or more activities of a project.

25. The method of claim 15, wherein the stage of the project life cycle is at least one of a business opportunity creation stage, a project proposal stage, a project contract stage and at least one project execution stage.

26. A computer program product for predictive categorization of risk of at least one project related activity, the categorization being performed for the project related activity in at least one stage of the project life cycle, the project related activity being categorized into one of a plurality of predetermined risk categories, the computer program product comprising:
program instruction means for collecting details pertaining to the project related activity being categorized and a predetermined set of details for categorizing the project related activity; and
program instruction means for categorizing the project related activity by applying discriminant analysis, the application of discriminant analysis comprising:
constructing a set of functions based on the predetermined set of details; and
applying the constructed set of functions on the details collected pertaining to the project related activity, the functions being applied for predicting the risk category of the project related activity.

27. The computer program product of claim 26 further comprising program instruction means for generating an output comprising the predicted risk category of the project related activity.
